(19) United States
(12) Patent Application Publication
(10) Pub. No.: US 2007/0036871 A1
(43) Pub. Date: Feb. 15, 2007

(54) TECHNIQUE FOR TREATMENT AND PREVENTION OF FUNGAL DISEASES IN GROWING GRAPES BY APPLICATION OF A SODIUM CHLORITE, UREA SULFURIC ACID SOLUTION

(76) Inventors: Wilferd J. Westerman, Calhoun, GA (US); Bruce Riggle, Eaton, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 11/462,318

(22) Filed: Aug. 3, 2006

Related U.S. Application Data
(60) Provisional application No. 60/706,716, filed on Aug. 9, 2005.

(51) Int. Cl. A01N 59/08

(52) U.S. Cl. 424/661

(57) ABSTRACT

A technique for reducing fungal disease in grape vineyards involves the generation of chlorine dioxide gas by dissolution of sodium chlorite with a urea sulphuric acid (monocarbamide dihydrogen sulphate) activating acid in water, followed by foliar application of the solution/gas to the vines.

### 1. RELATED APPLICATION

The present application claims priority of U.S. Provisional Application No. 60/706,716, filed Aug. 9, 2005, which is incorporated herein in its entirety by this reference.

### 2. FIELD OF THE INVENTION

The present invention relates to the treatment and prevention of fungal diseases in growing grapes. More particularly, the present invention relates to the control of fungal diseases by application of a fungicide to growing grapes, especially grapes grown for wine.

### 3. BACKGROUND OF THE INVENTION

Plant diseases caused by fungal organisms are responsible for the loss of yields in many crops. For example, in grains and legumes where the mature seed portion of the plant, e.g., the bean, wheat grain or corn kernel, is ultimately harvested, losses can be substantial. Despite significant scientific advances in fungicidal development in the last 50 years, many such fungal diseases in such plants remain partially or completely uncontrolled.

For example, and as more fully described in an online publication by R. W. Stack of the Plant Pathology Dept. North Dakota State Univ. entitled Return of an Old Problem: FUS acidrium Head Blight of Small Grains (www.aspnet.org/education/feature/FHB/), small grain crops such as wheat, rye and barely are susceptible to fusarium head blight, a disease which is increasing worldwide. In the U.S. and Canada, the Red River Valley of North Dakota. Minnesota and Manitoba has recently experienced six years of the disease. Infection spreads readily, in part because the spores are forcibly shot into the air, thereby increasing the dispersion of the fungus. Wheat, rye and barley are susceptible not only when the heads are flowering but also during later stages. During early stages of plant growth, the florets are killed so that no kernel develops. When infection occurs thereafter, florets are infected and bare partially developed and infected kernals, which appear “scabby”. Infections occurring after kernels are filled may appear normal but carry the fungus and may contain mycotoxins. Wet environments particularly favor the spread and growth of fusarium head blight. While chemical control of the fungal disease by use of fungicide sprays are of interest, in North America it is reported that “the best fungicide applications may provide a 50-60% reduction in FHB with a concomitant reduction in damaged kernels.” Id.

Other fungal diseases, in particular the different forms of rust, remain highly problematic. Indeed, Asian soybean rust (Phakopsora pachyrhizi), the presence of which was first confirmed in the continental U.S. in late 2004, is much in the news in the summer of 2005, as the seasonal tropical storms which annually impact the U.S. southeast from Florida and Mississippi northward, and then inland to the north central states, are predicted to cause further spread of Asian soybean rust. Soybean rust causes significant crop losses, with rust symptoms occurring five days or more after infection. When the rust pustules present on the underside of soybean leaves break, thousands of fungal spores are released into the air. An infected plant may produce 6,000,000 rust spores per day.

Certain fungal diseases are especially problematic for grapes. As reported by the Michigan State University Integrated Pest Management Program “[d]owny mildew is a widespread, serious disease of grapevines. Initial leaf symptoms are light green or yellow spots, sometimes called “oil spots” because they may appear greasy. Under humid conditions, white, fluffy sporulation can be seen on the lower leaf surface. The lesions eventually turn brown as the infected tissue dies. Severely infected leaves drop prematurely, which can reduce winter hardiness of the vine. Infected flower clusters dry up or become covered with white spores under humid conditions. Infected berries turn a mottled dull-green or reddish purple and readily fall from the cluster. Although berries become resistant to infection within three weeks after bloom, the rachis remains susceptible for several weeks longer.”

As reported by ASPnet.org, “Powdery mildew, caused by the fungus Uncinula necator (Schw) Burr., has been a problem on California grapes since commercial production began more than a century ago. It is, without a doubt, the most enduring and persistent disease problem faced by grape producers, especially among California Vitis vinifera vineyards.” www.apsnet.org/online/feature/pmilderw/.

Powdery mildew is especially a problem on grapes, because it “over-winters on infected fallen leaves, inside dormant buds or on the surface of the vine . . . [and] is favored by periods of low rainfall and only moderately high relative humidity (70-80%).” University of New Hampshire Cooperative Extension, “Powdery Mildew of Grape”, Pest Fact Sheet 35. More particularly, and as reported by The University of California Cooperative Extension, “the fungus overwinters as tiny oospores in leaf debris on the vineyard floor. In the spring, the oospores germinate in water to form sporangia. The sporangia liberate small swimming spores, called zoospores, if standing water is present. The zoospores are disseminated by rain splash to grape tissues where they swim to the vicinity of stomata and encyst. Encysted zoospores infect grape tissues by forming germ tubes that enter stomata and from there invade inner tissues of the plant. At night during periods of high humidity and temperatures above 13° C. (55° F.), the fungus sporulates by forming sporangia on numerous branched structures, called sporangiophores, that protrude out through stomata. Sporulation only occurs on plant surfaces that contain stomata, such as the undersides of leaves, and it gives the surface of the lesions its white, downy appearance. Sporangia are disseminated by wind or rain splash to other susceptible tissue. There they liberate zoospores into water films formed by rain or dew and these zoospores initiate secondary infections. Infections can occur in as little as 2 hours of wetting at 25° C. (77° F.) or up to 9 hours at 6° C. (43° F.). Infections are usually visible as lesions in about 7 to 12 days, depending on temperature and humidity. The number of secondary infection cycles depends on the frequency of suitable wetting periods that occur during the growing season and the presence of susceptible grape tissue.”

Thus, with respect to grape vines, the fungus not only grows on the foliar surfaces, but also spreads systemically. These portions of the fungal population which are not exposed to the surface are very difficult to eradicate. Intuitively, one might not expect a surface direct treatment to be highly effective against such fungal populations. So, while fungal diseases are generally difficult to eliminate and control in many crops, due in part to the steep exponential growth of fungus generally through spore dispersion and also to the hard spore coverings protecting the spores from various environmental conditions and a number of fungicides, additionally, the mode of growth of fungal diseases in grapes is a factor which makes prevention and eradication difficult.

It has been further reported that if the grower utilizes a regular spray program to control powdery mildew and black rot using certain pesticides, the grapes may be vulnerable to downy mildew, for which the fungicide metalaxyl (mixed with copper or mancozeb) has been shown to be effective against downy mildew but cannot be used within 66 days of harvest.

Fungicide resistance is a ongoing problem with certain pesticides. For example, sterol biosysthesis inhibitor (SBI) fungicides such as triadimefon are generally considered no longer effective against powdery milew due to resistance, so that SBI spray intervals are often shortened.

Strobilurin fungicides are reported as highly effective for controlling major fungal diseases of grapes in the Midwest. M. A. Ellis, Notes on New Fungicides for Grape Disease Control, The Ohio State University, February 2001. However, recommended use of many strobilurins limit their use to 4 or less times per season, to prevent the development of fungicide resistance.

For example, Headline® fungicide is a fungicide treatment registered to BASF Corporation under U.S. Environmental Protection Agency (EPA) Registration No. 7969-186. It is approved for use with various foodstuffs, including dry beans and grass grown for seed, barley, rye and wheat. The active ingredient is pyraclostrobin which is present in an equivalent of 2.09 pounds per gallon. The product includes petroleum distillates and is classified as a Group 11 fungicide The Headline® fungicide label includes a Resistance Management statement that “Fungal isolates resistant to group 11 fungicides, such as pyraclostrobin . . . may eventually dominate the fungal population if group 11 fungicides are used predominantly and repeatedly in the same field in successive years as the primary method of control for the targeted pathogen species. This may result in reduction of disease control by Headline or other group 11 fungicides.” The crop-specific restrictions and limitations for barley, rye, and wheat include a maximum rate per acre per application of 9 fluid ounces and a maximum number of applications per season of 2. Barley and rye must be treated no later than at 50% head emergence. Wheat must be treated by the end of flowering. Wheat cannot be harvested within 14 days of last application. The label contains crop-specific restrictions and limitations for dry beans (not including soy beans), but does list rusts as target diseases for dry beans and also for wheat.

After issuance of the Headline® fungicide label, EPA Reg. No. 7969-186, a Technical Information Bulletin for Using Reduced Rates of Headline® Fungicide to Control Tan Spot on Wheat Grown in Minnesota, North Dakota or S. Dak. was published in 2002. The Bulletin notes that for early season tan spot control, 3 fl. oz per acre of Headline is recommended, in which case a second application is strongly recommended to protect the emerged flag leaf. The 2 application/season limit is reiterated in the Bulletin.

As an alternative to the strobilurins, dusting sulfur is also used as a fungicide-insecticide to fight powdery mildew in grapes. A standard application rate is 8 to 15 pounds per acre. Applications can begin when shoots are 6-8 inches long and may be repeated as necessary. Certain types of grapes may be injured by sulfur, making sulfur is phytotoxic to such varieties. Even when phytotoxicity is not a problem, warm temperatures can preclude use of sulfur Moreover, multiple treatments are typically needed. One regimen of treatment with sulfur suggests 5 sprays: (1) when blossoms are beginning to open (if powdery mildew was a serious problem the previous year); (2) immediately after bloom, (3), when berries are pea size, (4) when berries in the cluster nearly touch and (5) when fruit starts to color. However successful such treatments are on some grapes, the treatment is not preferred for sulfur sensitive varieties such as Concord grapes.

Moreover, the presence of residual sulfur on grapes is a serious problem for wine production, as sulfur residues have the potential for forming hydrogen sulfide and other sulfur compounds during fermentation. Not only are sulfur compounds detectable in wines at very low levels, sulfite allergies are a serious problem. Accordingly, the FDA require foods such as wine, to indicate the presence of sulfites on the label. The FDA estimates that one in 100 people is sulfite sensitive to some degree, but for the 10% of the population who are asthmatic, up to 5% are at risk of having an adverse reaction to the substance. The most significant sulfite sensitivity reactions occur in susceptible asthmatics. The number of asthmatic patients included in the sulfite sensitive group is presently estimated at 500,000 in the U.S.

One antimicrobial agent that has long been used as a surface decontaminant is sodium chlorite. Sodium chlorite is a salt and when mixed in water to form a solution and when subjected to an acid, it will convert to chlorine dioxide. This activation technique is often utilized because chlorine dioxide gas can be explosive, and thus shipping of containers of chlorine dioxide gas is not preferred. The acid used for activation purposes can be either a mono- or multi-valent acid and be either in-organic or organic. Vulcan Chemicals (TDS 600-103) advises that the maximum theoretical conversion of sodium chlorite to chlorine dioxide following acid activation is 80%. In the presence of a mono-valent acid, such as hydrochloric acid, the following reaction is expected to occur:
5NaClO₂+4HCl→4ClO₂(g)+5NaCl+2H₂O
with 5 moles of sodium chlorite required to generate 4 moles of chlorine dioxide. In the presence of a di-valent acid, such as sulfuric acid, the following reaction is expected to occur:
4NaClO₂+H₂SO₄→2ClO₂(g)+NaCl+NaClO₃+2NaSO₄+H₂O
with 4 moles of sodium chlorite required to generate 2 moles of chlorine dioxide. However, the use of diluted solutions of strong acids containing no other compounds, such as aqueous hydrochloric or sulfuric acid, can drive the production of ClO₂ so quickly that while some of the rapidly produced ClO₂ reacts immediately on contact, much of the gas is lost to atmosphere.

Accordingly, hard surface sanitation, where immediate cleansing of a relatively flat surface is desired, is a primary use of chlorine dioxide applications. Hard surfaces in public places, (e.g., restaurant countertops), is one primary use for chlorine dioxide. Other widespread uses include surface and water treatment sanitation in animal confinement areas such as barns, poultry houses, boarding kennels and the like.

Aside from surface sanitation use on restaurant countertops and the like in public facilities, the EPA has approved the use of sodium chlorite for surface application to certain harvested vegetables and to certain seeds prior to planting. For example, sodium chlorite was approved in 1995 as a seed-soak treatment prior to planting and growing brassica, leafy vegetables and radishes. See 40 C.F.R. §180.1070. More recently in 2003, the EPA approved the use of chlorine dioxide on stored potatoes by acid activation of sodium chlorite to produce chlorine dioxide. Supplemental labeling of Purogene® for treatment of stored potatoes lists application rates of 200 and 400 parts per million (ppm) of sodium chlorite to stored potatoes to control late blight (Phytophthora infestans).

The U.S. Food and Drug Administration has also approved the uses of acidified sodium chlorite solutions as an antimicrobial agent in water to treat harvested fruits and vegetables. The approval is limited to application as dip or direct spray at concentrations of between 500 and 1,200 ppm when used with an approved acid at a level sufficient enough to achieve a solution pH of 2.3 to 2.9, See 21 C.F.R. §173.325.

Continuous chlorine dioxide gas treatments on fresh supermarket purchased strawberries has also been tested to determine the efficacy in reducing counts of E. coli O0157:H7 and Listeria monocytogenes. The strawberries were treated with chlorine dioxide produced by a generator using chlorine gas.

Thus it can be seen there remains a need for a fungicide which prevents or substantially controls the spread of fungal diseases in grape vineyards. Preferably, the mode of action of such a fungicide should be such that fungal resistance is not expected and control of a target fungal disease should not lead to increase in incidence of other fungal diseases. Preferably, limitations on the number of applications or the timing of applications to a single crop should be minimized, so that if multiple fungal infestations or late season infestations occur, use of an effective fungicide is not precluded. Also, late-season applications should preferably be possible. Finally, a fungicide which doesn't require substantial amounts for effective treatment is preferred, for both economy of application and risk of health hazards to workers which may increase with increases in concentration of chemical applications.

### SUMMARY OF THE INVENTION

The present invention relates to a method of reducing fungal disease in growing grapes. The method involves the generation of chlorine dioxide gas by dissolution of sodium chlorite with an acid solution comprising urea sulphuric acid (also referred to as monocarbamide dihydrogen sulphate) in water, which functions as an activating acid, releasing chlorine dioxide gas to the air adjacent the grapes, and also remaining in solution on the leaves and stems, thereby functioning as a foliar treatment over an extended period. In a most preferred embodiment of the technique of the present invention, the application rate of the sodium chlorite active ingredient to control fungal diseases in growing grapes is from about 0.1 to about 0.15 pounds per acre (“lb/acre”), with preferred application rates of from about 0.05 to about 1 lb/acre active ingredient and acceptable application rates from about 0.01 to about 2 lb/acre active ingredient.

### DETAILED DESCRIPTION

The present invention relates to a method of reducing fungal disease in grape vineyards. The method involves the generation of chlorine dioxide gas by dissolution of sodium chlorite with an activating acid in an aqueous solution and by foliar application of the gas to the vines. The most preferred acid solution contains urea sulphuric acid, also referred to as monocarbamide dihydrogen sulphate. The treatment method of the present invention is not expected to promote fungal resistance, as chlorine dioxide's mode of action involving oxidation, which occurs at multiple sites, is not limited to very particularized positions on one or more target enzymes.

In a most preferred embodiment of the technique of the present invention, the application rate of the sodium chlorite active ingredient to control fungal diseases in growing grapes is from about 0.1 to about 0.15 pounds per acre (“lb/acre”), Preferred application rates range from about 0.05 to about 1 lb/acre active ingredient. Acceptable application rates are from about 0.01 to about 2 lb/acre active ingredient,

### EXAMPLE I

An aqueous solution containing 2.58 pounds of sodium chlorite per gallon is obtained from Vulcan Chemicals under its Technical Sodium Chlorite Solution 31.25 label. In order to achieve a 0.06 pound of active ingredient per acre application rate, a predetermined amount of the sodium chlorite solution was added to a spray tank partially filled with water. For each 3 fluid ounces of sodium chlorite solution added to the tank, 2 fluid ounces of concentrated urea sulfuric acid was added and the tank was then topped off with water. Foliar spray application to wheat then followed promptly.

### EXAMPLE II

A field fungicide test on spring wheat was conducted on acreage near Stratford, S. Dak., on which soybeans had been planted and harvested the previous year. After the spring wheat was planted, standard weed control herbicides were applied. Bronate® (bromoxynil—a product of Bayer CropScience) was applied to minimize growth of broadleaf weeds and Puma® (fenoxaprop-P-ethyl—a product of Aventis CropScience) was applied to minimize growth of wild oats and foxtail.

The sodium chlorite active ingredient solution to which the urea sulfuric acid activator was added in accordance with Example I was applied to selected acreage at a rate of 0.06 lbs. sodium chlorite active ingredient per acre. Headline® fungicide was applied to adjacent acreage at a rate of 6 fluid ounces, which is equivalent to 0.1 lb. active ingredient per acre, the recommended rate for the control of Tan Spot (Pyrenphthora tritici-repents). Untreated plants in areas adjacent the Headline®-treated acreage received no fungicide treatment.

The fungicide treatments were applied two times during the growing season. The first application was made at flag leaf stage, when the wheat was 2 to 3 inches tall at flag leaf stage. The application was made to prevent rust diseases. The application was made using a ground rig at 10 gallon spray volume per acre using T-Jet 1005 nozzles.

The second application was made at the heading or flowering stage to prevent Fusarium head blight. This application was made with a Husky AgCat model monoplane at 4.6 gallon spray volume per acre, using standard nozzles to reduce drift. The aerial applications were made during early morning hours, following standard conditions to prevent spray drift. No applications were made when wind speeds were 10 mph or greater.

The Headline® fungicide treatment was prepared by addition of the Headline® fungicide to a spray tank that was half full with water, after which the tank was topped off with water. Spray application followed.

Fungal disease pressure was observed during the course of the growing season in the untreated adjacent areas. Rust was observed at the flag leaf stage. Fusarium head blight was observed by the presence of white wheat. Spotting on foliage was also observed.

The spring wheat acreage treated with the Example I treatment out yielded the acreage treated with Headline® fungicide by from 5 to 8 bushels more of wheat per acre. The differences in yield were determined from the harvest combine yield monitor, The wheat plants treated with the Example I treatment were observed to have less spotting and to be 30 to 40% healthier and greener looking than the wheat plants treated with the Headline® fungicide treatment. At harvesting, the combine operators even commented that the plots that had been treated with the Example I fungicide looked better than the acreage treated with Headline® fungicide. Indeed, white wheat heads, an indicator of Fusarium head blight, were found in the acreage treated with Headline® fungicide, but were not found in the acreage treated with the Example I fungicide.

### EXAMPLE III

A second field fungicide test the year following the treatments and harvest described in Example II, was conducted on spring wheat on the same acreage near Stratford, S. Dak. As in Example II, after the wheat was planted, standard weed control herbicides were applied. Bronate® (bromoxynil—a product of Bayer CropScience) was applied to minimize growth of broadleaf weeds and Puma® (fenoxaprop-P-ethyl—a product of Aventis CropScience) was applied to minimize growth of wild oats and foxtail.

Application of the fungicide treatments was substantially the same as described in Example II above. Once again, in addition to the herbicide treatments, acreage was treated in one of three ways: (1) with the Example I fungicide, (2) with Headline® fungicide, or (3) with no fungicide. Fungal pressure was again observed on the untreated control plot, with spotting symptoms visible on plant foliage.

The yield differences reported in Example II above between the acreage treated with Headline® fungicide and the acreage treated with the Example I fungicide was the same at 5 to 8 bushel increase per acre in the Example I acreage. However, white wheat heads were not found in any of the treated plots, indicating that there was very little if any Fusarium head blight pressure. There were no visual differences and no yield differences between acreage treated with the Headline® fungicide and the untreated control plants, although both types of plants showed spotting and visual symptoms of fungal disease. Once again, plants in the acreage treated with the Example I fungicide appeared markedly healthier than the other plants.

It is noted that the increase in yield cannot be attributed to presence of the urea contributed by the urea sulfuric acid. At the application rate described in Example I, the urea sulfuric acid would be contributing only 0.046 pound of nitrogen per acre per growing season. In contrast, the Mississippi State University Extension Service recommends 90 to 140 lb/acre as the spring nitrogen rate for wheat, although the rate may be lessened if there is a carryover of nitrogen from the previous crop. Although in the case of Example I, there would be expected to have substantial carryover of nitrogen from the previous year's soybean crop, cutting the recommended rate of 90 lb/acre in half (to 45 lb/acre), the amount of nitrogen in the urea used in Example 1 would not be expected to be fertilizer contributor enhancing the crop yield in any significant way.

In view of the agronomics of pesticide application, where application of the smallest effective amount has both cost-saving and environmental implications, the most preferred application rate to wheat and legumes presently known is 0.06 pound per acre of the sodium chlorite active ingredient. The efficacy in preventing and reducing fungal diseases in a growing crop at such a low application rate was quite surprising. It should be noted, however, that while sodium chlorite is an weak oxidizing agent, and the primary mode of action of the chemical reaction involved in the method of the present invention results from oxidation by the chlorine dioxide gas generated in the reaction, the imprecision necessarily present in calculating the percentage of sodium chlorite converted to chlorine dioxide, has resulted in a convention of identifying the active ingredient as the sodium chlorite, for purposes of application rate calculations.

While 0.06 lb/acre active ingredient is most preferred when practicing the present invention with grain and legume crops, preferred rates of application range from 0.04 to 0.08 lb/per acre of the active ingredient of the present invention. Economical range of application rates of active ingredient range from 0.02 to 1 lb/acre. Acceptable results are expected to be achieved with application rates of from 0.005 to 10 lb/acre of the active ingredient.

The most preferred acid activator used in the method of the present invention is urea sulfate. Other preferred acid activators include hydrochloric acid, nitric acid and sulfuric acid, as well as organic acids such as citric acid. Food grade acids are preferred.

It is noted that as with spring wheat, grape-producing vines that are treated with foliar fungicides often use water as a carrier. The foliar application technique of the present invention utilizes an aqueous solution of sodium chlorite and urea sulfuric acid. This practice can be easily incorporated into existing crop protection practices for the treatment and prevention of foliar fungal diseases in grape-producing vines. The present invention is expected to have particular utility in vineyards producing grapes for wine, where elimination of pesticide residues is highly desirable.

### EXAMPLE IV

Field trials were conducted to evaluate whether the grape fungicide treatment of the present invention involving sodium chlorite/urea sulphuric acid solution/chlorine gas generation, could be as effective as sulphur dusting as a fungicide against powdery mildew, at substantially lower per acre sulphur application rates. The tests were performed in the hope of employing the technique of the present invention to reduce the risk of excess sulphur concentrations on grapes at harvest, in wine or on table fruit, to successfully treat sulphur-intolerant grape varieties such as Concord grapes, and to provide an alternative to resistance-prone fungicides.

Carignane grape vines, characterized as highly susceptible to powdery mildew, were treated by foliar applications at 10 day intervals. The first application was post-bloom, and the second and applications were during fruit development. A mistblower was employed at 10 psi using an air-blast nozzle with a spray volume of 106.7 gallons of water/acre. Four different treatments were applied on distinct plots for each application, as follows:
(1) untreated control;
(2) 5 fluid oz/acre of a 25% active ingredient NaClO₂ solution in 3 fluid oz/acre of concentrated urea sulphuric acid (“US”) for an effective rate of 0.06 lb/acre sulphur and 0.1 lb/acre active ingredient NaClO₂—(“lowest rate NaClO₂/US”)
(3) 7.5 fluid oz/acre of a 26% active ingredient NaClO₂ solution in 4.5 fluid oz/acre of concentrated urea sulphuric acid for an effective rate of 0.09 lb/acre sulphur and 0.15 lb/acre active ingredient NaCl₂—(“low rate NaClO₂/US”); and
(4) dusting sulphur at 6 lb/acre active ingredient.

Ten days after each treatment, leaves and fruit were examined for symptoms, with the percent (“%”) of leaves and fruit with disease symptoms quantified, and the % severity on symptomatic leaves and fruit assessed, as summarized in TABLES 1, 2 and 3 below.

TABLE 1

| RATED JUNE 22 | % leaves | % severity | % fruit | % severity |
|---|---|---|---|---|
| AFTER | w/ | of infected | w/ | of infected |
| JUNE 12 TREATMENT | symptoms | leaves | symptoms | fruit |
| 1-control | 10.5 | 11.75 | 55 | 29.5 |
| 2-lowest rate NaClO₂/US | 11 | 10.75 | 37.5 | 26 |
| 3-low rate NaClO₂/US | 7.75 | 7.5 | 27.5 | 13.5 |
| 4-6 lb/acre sulphur | 7.25 | 6.75 | 26.25 | 16 |

Ten days after the first treatment, summarized in TABLE 1 above, while the lowest rate NaClO₂+US acid treatment did not appreciably control symptoms in leaves beyond the disease level in the untreated control, a measurable decrease in fruit symptoms was identified. A decrease of more than 20% in the number of fruit with symptoms was measured—55% of fruit with symptoms in control; 37.5% of fruit with symptoms in lowest rate application. The severity of infection in the fruit treated with the lowest treatment was measured at 10% less than that of the control. The low rate NaClO₂+US acid treatment evidenced fungal disease control comparable to the 6 lb/acre dusting sulphur treatment, at a sulphur level of about 1/60 of the dusting sulphur application rate.

TABLE 2

| RATED JULY 3 | % leaves | % severity | % fruit | % severity |
|---|---|---|---|---|
| AFTER | w/ | of infected | w/ | of infected |
| JUNE 22 TREATMENT | symptoms | leaves | symptoms | fruit |
| 1-control | 15.75 | 12.5 | 53.75 | 35 |
| 2-lowest rate NaClO₂/US | 10 | 10 | 37.5 | 29.5 |
| 3-low rate NaClO₂/US | 11.75 | 10.25 | 22.5 | 11.5 |
| 4-6 lb/acre sulphur | 10 | 11 | 20 | 15 |

Ten days after the second treatment, summarized in TABLE 2 above, the lowest rate NaClO₂+US acid treatment was controlling symptoms at measurably lower levels than the disease symptoms in the untreated control. Again, the low rate NaClO₂+US acid treatment evidenced fungal disease control comparable to the 6 lb/acre dusting sulphur treatment, at a sulphur level of about 1/60 of the dusting sulphur.

TABLE 3

| RATED JULY 12 | % leaves | % severity | % fruit | % severity |
|---|---|---|---|---|
| AFTER | w/ | of infected | w/ | of infected |
| JULY 3 TREATMENT | symptoms | leaves | symptoms | fruit |
| 1-control | 21.25 | 35 | 62.5 | 63.75 |
| 2-lowest rate NaClO₂/US | 11.75 | 13 | 45 | 27.5 |
| 3-low rate NaClO₂/US | 16.25 | 8.75 | 40 | 11.25 |
| 4-6 lb/acre sulphur | 5.25 | 4.25 | 32.5 | 21.25 |

Ten days after the third treatment, summarized in TABLE 3 above, the lowest rate NaClO₂+US acid treatment was controlling symptoms at substantially lower levels than the disease symptoms in the untreated control. While the dusting sulphur treatment evidenced substantially lower disease infection in leaves over the low rate NaClO₂+US acid treatment, the severity of disease symptoms in the infected fruit was the lowest of all treatments with the low rate NaClO₂+US acid treatment. Since, in grape production, it is ultimately the quality of the grapes which is important to the consumer, not necessarily the leaf quality, controlling the severity of infection on the infected fruit is of highest importance.

An aspect of the tests not reflected in the data above is the consistency of results achieved with the low NaClO₂+US acid treatment, compared to the sulphur treatment. Individual plot data appears below in TABLES 4, 5 and 6.

TABLE 4

| RATED JUNE 22 | % leaves | % severity | % fruit | % severity |
|---|---|---|---|---|
| AFTER | w/ | of infected | w/ | of infected |
| JUNE 12 TREATMENT | symptoms | leaves | symptoms | fruit |
| 3-low rate NaClO₂/US | 5 | 5 | 30 | 10 |
| | 5 | 5 | 30 | 12 |
| | 15 | 10 | 30 | 12 |
| | 6 | 10 | 20 | 20 |
| | 7.75 | 7.5 | 27.5 | 13.5 |
| 4-6 lb/acre sulphur | 2 | 2 | 30 | 8 |
| | 20 | 18 | 40 | 30 |
| | 2 | 2 | 20 | 6 |
| | 5 | 5 | 15 | 20 |
| | 7.25 | 6.75 | 26.25 | 16 |

TABLE 5

| RATED JULY 3 | % leaves | % severity | % fruit | % severity |
|---|---|---|---|---|
| AFTER | w/ | of infected | w/ | of infected |
| JUNE 22 TREATMENT | symptoms | leaves | symptoms | fruit |
| 3-low rate NaClO₂/US | 12 | 10 | 30 | 14 |
| | 15 | 11 | 30 | 12 |
| | 10 | 10 | 20 | 10 |
| | 10 | 10 | 10 | 10 |
| | 11.75 | 10.25 | 22.5 | 11.5 |
| 4-6 lb/acre sulphur | 10 | 15 | 20 | 15 |
| | 20 | 20 | 40 | 30 |
| | 2 | 4 | 15 | 10 |
| | 8 | 5 | 5 | 5 |
| | 10 | 20 | 20 | 15 |

TABLE 6

| RATED JULY 12 | % leaves | % severity | % fruit | % severity |
|---|---|---|---|---|
| AFTER | w/ | of infected | w/ | of infected |
| JULY 3 TREATMENT | symptoms | leaves | symptoms | fruit |
| 3-low rate NaClO₂/US | 20 | 5 | 40 | 15 |
| | 20 | 10 | 40 | 10 |
| | 5 | 10 | 30 | 10 |
| | 20 | 10 | 50 | 10 |
| | 16.25 | 8.75 | 40 | 11.25 |
| 4-6 lb/acre sulphur | 2 | 5 | 10 | 10 |
| | 15 | 5 | 60 | 40 |
| | 2 | 5 | 40 | 25 |
| | 2 | 2 | 20 | 10 |
| | 5.25 | 4.25 | 32.5 | 21.25 |

As can be seen in TABLES 4, 5 and 6, control of fungal disease in grapes at consistent levels was achieved with low levels of NaClO₂+US acid treatments, even in the highly sensitive Carignane grape variety. Acceptable application rates range from about 0.01 to about 2 lb/acre NaClO₂ active ingredient. Preferred application rates range from about 0.05 to 1 lb/acre NaClO₂ active ingredient, Most preferred application levels range from about 0.1 to 0.15 lb/acre NaClO₂ active ingredient.

While there have been described above the principles of the present invention in conjunction with specific compositions, application rates and crops, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

1. A method of reducing fungal disease in grapes on vines in a vineyard comprising the steps of:
mixing an aqueous sodium chlorite solution and urea sulphuric acid to produce a solution containing unreacted sodium chlorite and generating chlorine dioxide gas; and
spraying the solution on the growing grapes and vines,
wherein the rate of application of sodium chlorite active ingredient is from about 0.01 to about 2 pounds per acre (“lb/acre”).

2. The method of reducing fungal disease of claim 1, wherein the rate of application of sodium chlorite active ingredient is from about 0.05 lb/acre to about 1 lb/acre.

3. The method of reducing fungal disease of claim 1, wherein the rate of application of sodium chlorite active ingredient is from about 0.1 lb/acre to about 0.15 lb/acre.

4. The method of reducing fungal disease of claim 1, wherein the grapes are grown for wine production.

5. The method of reducing fungal disease of claim 2, wherein the grapes are grown for wine production.

6. The method of reducing fungal disease of claim 3, wherein the grapes are grown for wine production.
